(19) United States
(12) Patent Application Publication
(10) Pub. No.: US 2021/0245151 A1
(43) Pub. Date: Aug. 12, 2021

(54) DUAL DIRECTION DISPENSERS

(71) Applicant: HEWLETT-PACKARD DEVELOPMENT COMPANY, L.P., Spring, TX (US)

(72) Inventors: Michael W. CUMBIE, Corvallis, OR (US); Chien-Hua CHEN, Corvallis, OR (US); Pavel KORNILOVICH, Corvallis, OR (US)

(21) Appl. No.: 17/049,761

(22) PCT Filed: Aug. 10, 2018
(86) PCT No.: PCT/US2018/046354

§ 371 Date: Oct. 22, 2020

(51) Int. Cl. B01L 3/00

(52) U.S. Cl. CPC B01L 3/50273; B01L 3/502715; B01L 2200/06; B01L 2300/0864; B01L 2300/0681; B01L 2200/0684; B01L 2200/087

(57) ABSTRACT

A dual direction dispenser may include a fluid channel, a first ejection orifice extending in a first direction from the fluid channel, a first fluid actuator to displace fluid through the first ejection orifice, a second ejection orifice extending in a second direction, different than the first direction, from the fluid channel and a second fluid actuator to displace fluid through the second ejection orifice.

### BACKGROUND

Microfluidics technology has found many applications in the biomedical field, cell biology, protein crystallization and other areas. The scale of microfluidics presents many design challenges.

### BRIEF DESCRIPTION OF THE DRAWINGS

FIG. 1 is a block diagram schematically illustrating portions of an example dual direction dispenser.

FIG. 2 is a sectional view illustrating portions of an example dual direction dispenser.

FIG. 3 is a flow diagram of an example dual direction dispensing method.

FIG. 4 is a sectional view illustrating portions of an example dual direction dispenser.

FIG. 5 is a sectional view illustrating portions of an example dual direction dispenser.

FIG. 6 is a sectional view illustrating portions of an example dual direction dispenser.

FIG. 7 is a sectional view illustrating an example inverted fluid ejector.

FIG. 8 is a sectional view illustrating an example dual direction dispenser.

FIG. 9 is a flow diagram of an example dual direction dispensing method.

FIG. 10 is a sectional view of portions of an example dual direction dispenser.

FIG. 11 is a sectional view of portions of an example dual direction dispenser.

FIG. 12 is a sectional view of portions of an example dual direction dispenser.

FIG. 13 is a sectional view of portions of an example dual direction dispenser.

FIG. 14 is a sectional view of portions of an example will direction dispenser.

Throughout the drawings, identical reference numbers designate similar, but not necessarily identical, elements. The FIG.s are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Microfluidic devices are often used to controllably eject fluid. Ejecting fluid in different directions often presents architectural and cost challenges. Prior microfluidic devices often rely upon separate and distinct components or a complex assembly of layers to eject fluid in different directions. Such prior microfluidic devices are often costly and space consuming.

The disclosed dual direction dispensers, methods and computer-readable mediums facilitate the selective and controlled dispensing of fluid in dual directions, different directions, from a single channel in a manner that lowers cost and that is more compact. The term “dual direction” or “dual directions” refers to multiple different directions, not necessarily directions that are directly opposite one another and not necessarily directions that are 180° from one another. Such dual direction dispensing may be utilized to direct a waste portion of fluid in the channel in a first direction to a first destination and a product or analyte portion of the fluid in the channel in a second direction to a second different destination. Such dual direction dispensers, methods and computer-readable mediums may direct a first analyte portion in a first direction from the channel to a first destination and a second analyte portion in a second direction from the channel to a second different destination. Such dispensing ejections may occur concurrently or sequentially.

The example dual direction dispensers, methods and computer readable mediums may be provided as part of a single microfluidic chip, package or platform. In such examples, two fluid ejection orifices may be situated or located along the single channel. Each of the fluid ejection orifices is associated with a corresponding fluid actuator that selectively and controllably ejects fluid from the fluid channel through the associated fluid ejection orifice.

In some implementations, the fluid actuators are supported on a single platform or substrate such that the electronics associated with the fluid actuators may also be provided on the same single platform or substrate, reducing fabrication cost and complexity. In such implementations, one of the fluid actuators may comprise an inverted fluid actuator, wherein the fluid ejection orifice and its associated fluid actuator are both on the same side of the fluid channel. In some examples, the fluid actuator and its associated fluid ejection orifice are formed or supported by the same layer of the dual direction dispenser.

As will be appreciated, examples provided herein may be formed by performing various microfabrication and/or micromachining processes on a substrate to form and/or connect structures and/or components. Substrates forming the various fluidic components may comprise a silicon-based wafer or other such similar materials used for microfabricated devices (e.g., glass, gallium arsenide, quartz, sapphire, metal, plastics, etc.). Examples may comprise microfluidic channels, fluid actuators, and/or volumetric chambers. Microfluidic channels and/or chambers may be formed by performing etching, microfabrication processes (e.g., photolithography), or micromachining processes in a substrate. Accordingly, microfluidic channels and/or chambers may be defined by surfaces fabricated in the substrate of a microfluidic device. In some implementations, microfluidic channels and/or chambers may be formed by an overall package, wherein multiple connected package components combine to form or define the microfluidic channel and/or chamber.

In some examples described herein, at least one dimension of a microfluidic channel and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels may facilitate capillary pumping due to capillary force. In addition, examples may couple at least two microfluidic channels to a microfluidic output channel via a fluid junction.

Each of the fluid actuators used to displace fluid through their associated fluid ejection orifices may comprise a thermal resistive fluid actuator, a piezo-membrane based actuator, and electrostatic membrane actuator, mechanical/impact driven membrane actuator, a magnetostrictive drive actuator, and electrochemical actuator, and external laser actuators (that form a bubble through boiling with a laser beam), other such microdevices, or any combination thereof.

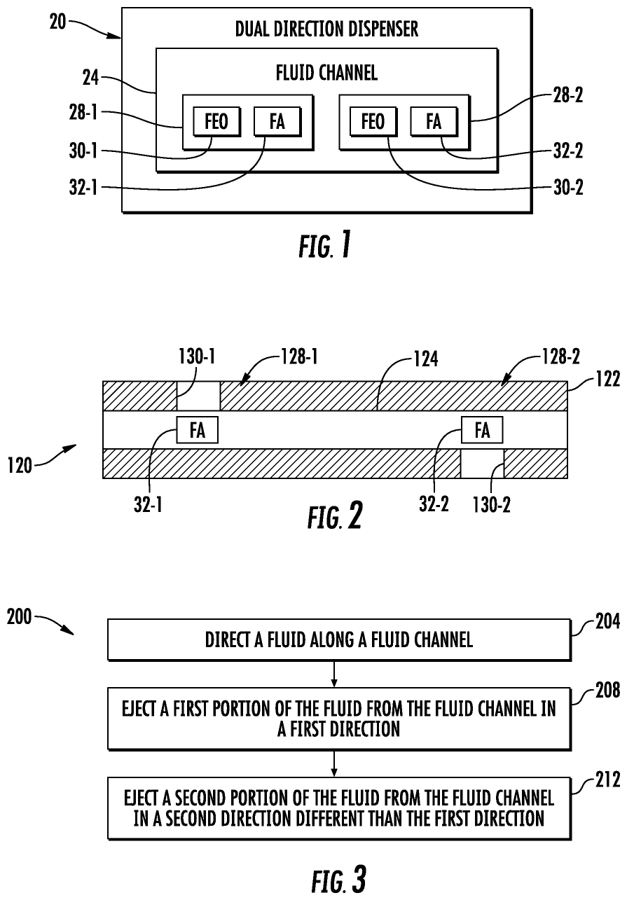

FIG. 1 is a schematic diagram illustrating portions of an example dual direction dispenser 20. Dual direction dispenser 20 facilitates the selective and controlled dispensing of fluid in two different directions from a single channel. Dual direction dispenser 20 may be provided as part of a single body, platform or chip. Dual direction dispenser 20 comprises fluid channel 24 and fluid ejectors 28-1, 28-2 (collectively referred to as fluid ejectors 28).

Fluid channel 24 comprises a passage formed within the body of dual direction dispenser 20 through which fluid may flow or otherwise be supplied to fluid ejectors 28. Fluid channel 24 is connected to both of fluid ejectors 28. Fluid channel 24 may be linear, serpentine or have other path shapes. In one implementation, fluid channel 24 comprises a microfluidic channel.

Fluid ejectors 28 selectively and controllably eject fluid or portions of fluid within channel 24 from channel 24. Fluid ejectors 28 are serially located along channel 24. In other implementations, fluid ejectors 28 are located in different segments of channel 24 that branch off of a primary segment of channel 24. In such implementations, fluid ejectors 28 may be provided in parallel.

Fluid ejector 28-1 comprises fluid ejection orifice 30-1 and fluid actuator 32-1. Similarly, fluid ejector 28-2 comprises fluid ejection orifice 30-2 and fluid actuator 32-2. Fluid ejection orifices 30-1, 30-2 (collectively referred to as fluid ejection orifices 30) extend through the body of dual direction dispenser 20 in different directions. In one implementation, fluid ejection orifices 30 have centerlines that are parallel to one another, but wherein the fluid ejection orifices 30 extend from channel 24 in opposite directions. In another implementation, fluid ejection orifices 30 have centerlines oblique to one another, wherein such centerlines extend from channel 24 in directions that are oblique with respect to one another. In some implementations, fluid ejection orifices 30 direct the ejected fluid to a location remote from dispenser 20. In other implementations, fluid ejection orifices 30 direct the ejected fluid to other reservoirs or passages formed in the body of dual direction dispenser 20 for further handling or processing of the ejected fluid.

Fluid actuators 32-1, 32-2 (collectively referred to as fluid actuators 32) displace fluid within channel 24 so as to eject fluid from channel 24 through their respective fluid ejection orifices 30. Each of fluid actuator 32 is specifically located and sized so as to eject fluid through its associated or corresponding fluid ejection orifice 30 without ejecting fluid through the fluid ejection orifice of the other fluid ejector 28. In one implementation, fluid actuators 32-1, 32-2 extend on or are formed upon different sides of channel 24. For example, in one implementation, fluid actuator 32-1 is on a first side of channel 24 that is opposite to fluid ejection orifice 30-1 while fluid actuator 32-2 is on a second different side of channel 24 that is also opposite to its associated fluid ejection orifice 30-2. In yet another implementation, even though the fluid ejection orifices extend from different sides of channel 24, both of fluid actuators 32 are on a same side of channel 24. In such an implementation, one of fluid actuator 32 may comprise an inverted fluid actuator, a fluid actuator that faces in a first direction yet displaces fluid for ejection in a second opposite direction.

In one implementation, both of such fluid actuators 32 may comprise similar types of fluid actuators. In other implementations, fluid actuators 32 may comprise different types of fluid actuators. Examples of various types of fluid actuators include, but are not limited to, a thermal resistive fluid actuator, a piezo-membrane based actuator, an electrostatic membrane actuator, mechanical/impact driven membrane actuator, a magnetostrictive drive actuator, and electrochemical actuator, and external laser actuator (that form a bubble through boiling with a laser beam), other such microdevices, or any combination thereof. In one implementation, each of fluid actuators 32 comprises a thermal resistive fluid actuator wherein electrical current is supplied to a thermal resistor so as to generate heat sufficient to vaporize adjacent fluid to create a drive bubble that pushes our expels non-vaporized fluid through the associated fluid ejection orifice 30.

FIG. 2 is a sectional view illustrating portions of an example dual direction dispenser 120. Dual direction dispenser 120 is formed in a single platform or body, such as a single chip or substrate. Dual direction dispenser 120 comprises body or package 122, fluid channel 124, and fluid ejectors 128-1, 128-2 (collectively referred to as fluid ejectors 128). Body or package 122 comprises at least one layer of material which defines passage 124 and orifices of fluid ejectors 128. Package 122 may be formed from layers of material such as a silicon-based wafer or other such similar materials used for microfabricated devices (e.g., glass, gallium arsenide, quartz, sapphire, metal, plastics, etc.).

Fluid channel 124 is similar to fluid channel 24 described above. Fluid channel 124 comprises a microfluidic passage formed within the body or package 122 of dual direction dispenser 120 through which fluid may flow or otherwise be supplied to fluid ejectors 128. Fluid channel 124 is connected to both of fluid ejectors 128. Fluid channel 124 may be linear, serpentine or have other path shapes.

Fluid ejectors 128 are similar to fluid ejectors 28. Fluid ejectors 128-1, 128-2 comprise fluid ejection orifices 130-1, 130-2 and fluid actuators 32-1, 32-2, respectively. Fluid ejection orifices 130-1, 130-2 (collectively referred to as fluid ejection orifices 130) extend in different directions from passage 124. In the example illustrated, orifices 130 extend in opposite directions, perpendicular to the centerline or general direction of channel 124 with their centerlines parallel to one another. In other implementations, fluid ejection orifices 130 may extend at oblique angles relative to one another or relative to channel 24.

Fluid actuators 32 are described above. Fluid actuators 32 (schematically shown) are each independently controllable to selectively eject fluid through their associated fluid ejection orifices 130. Fluid actuators 32 are located, sized and controlled so as to not displace fluid through the fluid ejection orifices of other fluid ejectors located along channel 124. Through the selective actuation of fluid actuators 32, fluid or portions of fluid within channel 124 may be directed through fluid ejection orifice 130-1 or fluid ejection orifice 130-2, concurrently or sequentially. In one implementation, one of fluid ejection orifices 130 may extend from channel 124 to a waste receptacle or reservoir wherein the other of channels 130 extends from channel 124 to a separate reservoir or a separate channel for directing the ejected fluid to a separate additional station where the fluid may undergo further processes such as amplification, mixing, heating, cooling and/or analysis.

FIG. 3 is a flow diagram of an example dual direction dispensing method 200. Method 200 facilitates the selective and/or controlled dispensing of fluid from a single channel in different directions to different destinations. Although method 200 is described in the context of being carried out by dispenser 20, in other implementations, method 200 may be likewise carried out by dispenser 120 or with any of the following described dual direction dispensers. Method 200 may likewise be carried out with similar dual direction dispensers.

As indicated by block 204, the fluid is directed along a fluid channel, such as fluid channel 24. As indicated by block 208, a first portion of the fluid may be ejected from the fluid channel in a first direction. As indicated by block 212, a second different portion of the fluid may be ejected from the fluid channel in a second direction different than the first direction. The ejection of the first portion of fluid and the ejection of the second portion of fluid may be carried out concurrently or sequentially. In one implementation, the first portion of fluid and the second portion of fluid may be co-mingled or mixed prior to being separated, wherein the separated portions are separately ejected. In another implementation, the first portion of fluid and the second portion of fluid may comprise serially arranged different portions of a stream of fluid.

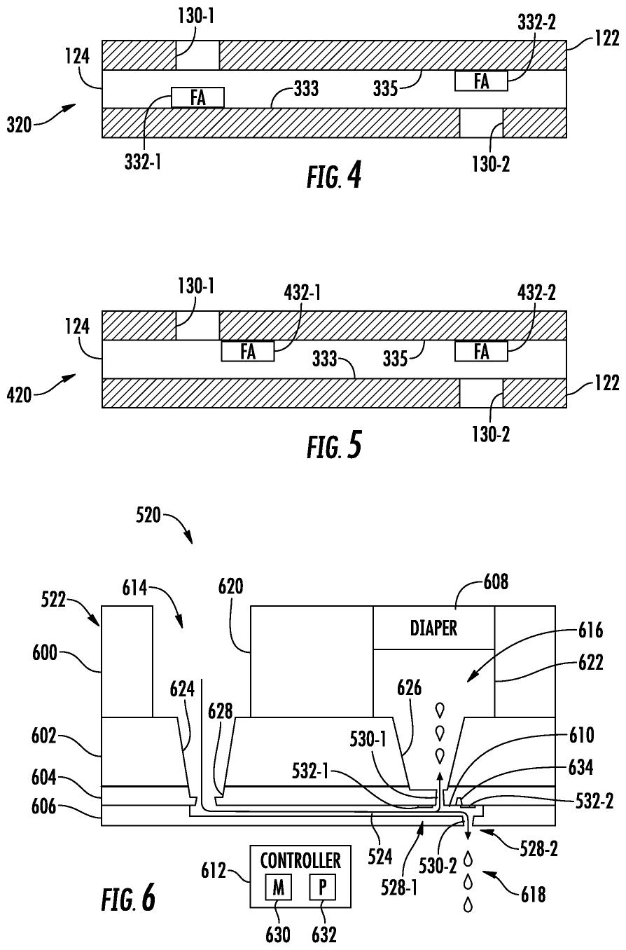

FIG. 4 is a sectional view illustrating portions of an example dual direction dispenser 320. Dual direction dispenser 320 is similar to dual direction dispenser 120 described above except that dual direction dispenser 320 is specifically illustrated as comprising fluid actuators 332-1 and 332-2 (collectively referred to as fluid actuators 332) in place of fluid actuators 32-1 and 32-2, respectively. Those remaining components of dual direction dispenser 320 which correspond to components of dual direction dispenser 120 are numbered similarly.

Fluid actuators 332-1, 332-2 (schematically shown) selectively and controllably eject fluid within channel 124 through their respective fluid ejection orifices 130-1, 130-2. Fluid actuator 332-1 is located on a first side 333 of channel 124 while fluid actuator 332-2 is located on a second different side 335 of channel 124. In the example illustrated, fluid actuator 302-1 is located on side 333 that is opposite to fluid ejection orifice 130-1 while fluid actuator 332-2 is located on side 335 that is opposite to fluid ejection orifice 130-2.

In one implementation, both of such fluid actuators 332 may comprise similar types of fluid actuators. In other implementations, fluid actuators 332 may comprise different types of fluid actuators. Examples of various types of fluid actuators include, but are not limited to, a thermal resistive fluid actuator, a piezo-membrane based actuator, an electrostatic membrane actuator, a mechanical/impact driven membrane actuator, a magnetostrictive drive actuator, and an electrochemical actuator, an external laser actuator (that forms a bubble through boiling with a laser beam), other such microdevices, or any combination thereof. In one implementation, each of fluid actuators 332 comprises a thermal resistive fluid actuator wherein electrical current is supplied to a thermal resistor so as to generate heat sufficient to vaporize adjacent fluid to create a drive bubble that pushes or expels non-vaporized fluid through the associated fluid ejection orifice 130-1, 130-2.

FIG. 5 is a sectional view illustrating portions of an example dual direction dispenser 420. Dual direction dispenser 420 is similar to dual direction dispenser 120 described above except that dual direction dispenser 420 is specifically illustrated as comprising fluid actuators 432-1 and 432-2 (collectively referred to as fluid actuators 432) in place of fluid actuators 32-1 and 32-2, respectively. Those remaining components of dual direction dispenser 420 which correspond to components of dual direction dispenser 120 are numbered similarly.

Fluid actuators 432-1, 432-2 (schematically shown) selectively and controllably eject fluid within channel 124 through their respective fluid ejection orifices 130-1, 130-2. Fluid actuator 432-1 and fluid actuator 432-2 are both located on one same side of channel 124. In one implementation, fluid actuators 432 are both located on or supported by same layer of package 122. In the example illustrated, fluid actuator 432-1 is located on side 335, the same side from which fluid ejection orifice 130-1 extends away from channel 124. In such an implementation, fluid actuator 432-1 comprises an inverted fluid actuator. Fluid ejection orifice 430-2 is similar to fluid ejection orifice 332-2 in that it is located on side 335 that is opposite to fluid ejection orifice 130-2.

In one implementation, both of such fluid actuators 432 may comprise similar types of fluid actuators. In other implementations, fluid actuators 432 may comprise different types of fluid actuators. Examples of various types of fluid actuators include, but are not limited to, a thermal resistive fluid actuator, a piezo-membrane based actuator, an electrostatic membrane actuator, a mechanical/impact driven membrane actuator, a magnetostrictive drive actuator, an electrochemical actuator, and an external laser actuator (that forms a bubble through boiling with a laser beam), other such microdevices, or any combination thereof. In one implementation, each of fluid actuators 432 comprises a thermal resistive fluid actuator wherein electrical current is supplied to a thermal resistor so as to generate heat sufficient to vaporize adjacent fluid to create a drive bubble that pushes our expels non-vaporized fluid through the associated fluid ejection orifice 130-1, 130-2.

FIG. 6 is a sectional view illustrating portions of an example dual direction dispenser 520. Like dual direction dispensers 20, 320, 420 described above, dual direction dispenser 520 facilitates the controlled ejection and dispensing of fluid in two different directions from a single fluid channel to different destinations. Like dual direction dispenser 420, dual direction dispenser 520 facilitates the fabrication of multiple fluid actuators on a single side of the fluid channel, wherein the multiple fluid actuators eject fluid in the different directions. Dual direction dispenser 520 is well-suited for selectively diverting portions of a fluid stream for microfluidic applications such as applications in the biomedical field, cell biology, protein crystallization and other areas. Dual direction dispenser 520 comprises fluid channel 524 and fluid ejectors 528-1, 528-2. In the example illustrated, dual direction dispenser 520 further comprises body 600, inlet-outlet layer 602, orifice layer 604, orifice layer 606, diaper 608, filter 610 and controller 612.

Fluid channel 524 comprises a channel formed within the package or platform of dual direction dispenser 520. In the example illustrated, fluid channel 524 comprises a channel formed between layers 604 and 606, receiving fluid through a fluid input 614.

Fluid ejectors 528-1, 528-2 (collectively referred to as fluid ejectors 528) comprise fluid ejection orifices 530-1, 530-2 (collectively referred to as fluid ejection orifices 530) and fluid actuators 532-1, 532-2 (collectively referred to as fluid actuators 532. Fluid ejection orifice 530-1 comprises a fluid ejection passage or nozzle extending from channel 524 through layer 604 to a first fluid discharge destination 616. Fluid ejection orifice 530-2 comprise a fluid ejection passage or nozzle extending from channel 524 through layer 606 to a second fluid discharge destination 618. Fluid ejection orifices 530 extend from channel 524 in different directions. In the example illustrated, fluid ejection orifices 530 extend from channel 530 in opposite directions, perpendicular to channel 524 and parallel to one another.

Fluid actuators 532 selectively and controllably eject fluid within channel 524 through their respective fluid ejection orifices 530-1, 530-2. Fluid actuator 532-1 and fluid actuator 532-2 are both located on one same side of channel 524. In one implementation, fluid actuators 532 are both located on or supported by layer 604. In such an implementation, fluid actuator 532-1 comprises an inverted fluid actuator. Fluid ejection orifice 530-2 is located opposite to fluid ejection orifice 530-2.

In one implementation, both of such fluid actuators 532 may comprise similar types of fluid actuators. In other implementations, fluid actuators 532 may comprise different types of fluid actuators. Examples of various types of fluid actuators include, but are not limited to, a thermal resistive fluid actuator, a piezo-membrane based actuator, an electrostatic membrane actuator, a mechanical/impact driven membrane actuator, a magnetostrictive drive actuator, and electrochemical actuator, an external laser actuator (that forms a bubble through boiling with a laser beam), other such microdevices, or any combination thereof. In one implementation, each of fluid actuators 532 comprises a thermal resistive fluid actuator wherein electrical current is supplied to a thermal resistor so as to generate heat sufficient to vaporize adjacent fluid to create a drive bubble that pushes or expels non-vaporized fluid through the associated fluid ejection orifice 530-1, 530-2.

Body 600 defines a first portion 620 of fluid input 614 and first portion 622 of discharge destination 616. In one implementation, body 600 may be formed from silicon. In other implementations, body 600 may be formed from other materials such as glass, gallium arsenide, quartz, sapphire, metal, plastics, etc. In one implementation body 600 may comprise an epoxy mold compound that is molded or otherwise formed against, and in some implementations, about layer 602, 604 and/or 606.

Inlet-outlet layer 602 comprises a layer of material between body 600 and orifice layer 604. Layer 602 forms a second portion 624 of a fluid inlet and a second portion 626 of the fluid discharge destination 616. In one implementation, layer 602 comprises a silicon-on-insulator (SOI) substrate. In other implementations, layer 602 may be formed from at least one layer of other materials. In some implementation, layer 602 is integrally formed as a single unitary body with layer 604.

Orifice layer 604 comprises a layer of material on which portions of a fluid actuator 528 are formed. In one implementation, orifice layer 604 comprises a thin film. In other implementations, orifice layer 604 comprises a layer or multiple layers forming a sliver which is mounted to layer 602. Orifice layer 604 forms a third portion 628 of fluid inlet 614 and further forms fluid ejection orifice 530-1 which extends through orifice layer 604.

Orifice layer 606 comprises a layer of material, or multiple layers of material, joined to layer 604. Layer 606 cooperates with layer 604 to form fluid channel 524. Layer 606 further defines fluid ejection orifice 530-2 which extends through portions of layer 606. Because both of fluid actuators 532 are supported by layer 604, along with their associated electronic circuitry, layer 606 may be simplified, omitting electrically conductive traces, circuitry or the like. As a result, layer 606 may be formed from epoxies such as SU8. In some implementation, layer 606 may be provided as a gasket joined to layer 604.

Diaper 608 comprises a gas permeable layer that retains fluid, in the form of a liquid, within the reservoir formed by discharge destination 616 while venting gas from the reservoir formed by discharge destination 616 to atmosphere. In one implementation, diaper 608 may be formed from cellulose fibers. In another implementation, diaper 608 may be formed from superabsorbent polymers or hydrogels. In yet other implementations, diaper 608 may be formed from a polymer, cotton, microfiber, plastic fiber, and the like.

Filter 610 comprise a constriction or other grid-like material within channel 524 and positioned between ejection orifice 520-1 and ejection orifice 530-2. Filter 610 blocks particles greater than a predetermined size such that particles greater than the predetermined size may not pass to the region of channel 524 adjacent to fluid ejection orifice 530-2. For example, in some implementations where a sample contains proteins and a contaminant/analyte to be detected or identified, the proteins may be concentrated to sizes sufficiently large so as to not be passable through or across filter 610, wherein the larger sized proteins may be discharged through fluid ejection orifice 530-1 while the remaining fluid containing the contaminants or other analytes to be identified and analyzed pass across filter 610 for ejection through fluid ejection orifice 530-2. In other implementations, the sample can include beads that carry an analyte of interest on their surfaces. In this example, the beads will be trapped by filter 610 and are prevented from being ejected by actuator 532-2 through ejection orifice 530-2.

In one implementation, filter 610 comprise a constriction in channel 524 formed by the protruding portion of layer 606. In other implementations, 610 may comprise a constriction formed by a protruding portion of layer 604. In yet other implementations, filter 610 may be bonded or otherwise joined to layer 604 and/or layer 606 between orifices 530.

Controller 612 controls the selective ejection of fluid through orifices 530. In one implementation, controller 612 (schematically shown) may be formed on or in layer 604 or on body 522 of dispenser 520. In yet other implementations, controller 612 may be provided remote from body 522, wherein the controller communicates through a wired or wireless connection with fluid actuators 532 on the body of dual direction dispenser 520. Controller 612 comprises a computer-readable medium 630 and a processing unit 632. Computer-readable medium 630 comprises a non-transitory computer readable memory that contains instructions for directing the operation of processor 632. Processor 632, following the instructions contained in medium 630, controls the actuation of fluid actuators 532. In one implementation, dual direction dispenser 520 further comprises at least one sensor 634 that senses the presence and/or flow of fluid. In such an implementation, processor 632, following instructions contained in media 630 may actuate fluid actuators 532 of injectors 528 based upon signals from the at least one sensor 634.

Although sensor 634 is illustrated as being located proximate to fluid ejection orifice 530-2 and fluid actuator 532-2, in other implementations, sensor 634 may alternatively or additionally be provided at other locations such as proximate to fluid ejection orifice 530-1, within a fluid discharge destination 616 or within fluid discharge destination 618. In one implementation, sensor 634 may comprise an impedance sensor.

FIG. 7 is a sectional view illustrating an example fluid ejector 728 that may be utilized in place of fluid ejector 528-1 or any of the fluid ejectors of the present disclosure having an inverted fluid actuator. Fluid ejector 728 comprises a substrate 730 (forming a portion of layer 604) having an array of nozzles 732 formed therethrough. The fluid ejector 728 further includes at least one thin film layer 730 forming the fluid actuator 532-1 and disposed on the substrate 730. As further shown by FIG. 7, conductive elements 736 electrically connect a circuit assembly 738, connected to controller 612 (shown in FIG. 6), to the fluid actuator on substrate 730 with electrical contact points 740. A molded panel 744 may be formed over substrate 730 to form fluid ejector 728, over circuit assembly 738, and conductive elements 736. In one implementation, the molded panel 744 may comprise an epoxy mold compound.

FIG. 8 is a sectional view illustrating portions of an example dual direction dispenser 820. Like dual direction dispensers 20, 320, 420 described above, dual direction dispenser 820 facilitates the controlled ejection and dispensing of fluid in two different directions from a single fluid channel to different destinations. Like dual direction dispenser 420, dual direction dispenser 820 facilitates the fabrication of multiple fluid actuators on a single side of the fluid channel, wherein the multiple fluid actuators eject fluid in the different directions. Dual direction dispenser 820 is well-suited for selectively diverting portions of a fluid stream for microfluidic applications such as applications in the biomedical field, cell biology, protein crystallization and other areas. Dual direction dispenser 820 comprises fluid channel 824 and fluid ejectors 828-1, 828-2. In the example illustrated, dual direction dispenser 820 further comprises body 900, inlet-outlet layer 902, die 903, orifice layer 904, orifice layer 906, diaper 908, filter 910, fluid analyzer 911 and controller 612 (described above).

Fluid channel 824 comprises a channel formed within the package or platform of dual direction dispenser 820. In the example illustrated, fluid channel 824 comprise a channel formed within layer 904, between layers 902 and 906, receiving fluid through a fluid input 914.

Fluid ejectors 828-1, 828-2 (collectively referred to as fluid ejectors 828) comprise fluid ejection orifices 830-1, 830-2 (collectively referred to as fluid ejection orifices 830) and fluid actuators 832-1, 832-2 (collectively referred to as fluid actuators 832). Fluid ejection orifice 830-1 comprises a fluid ejection passage or nozzle extending from channel 824 through layer die 903 to a first fluid discharge destination 916. Fluid ejection orifice 830-2 comprises a fluid ejection passage or nozzle extending from channel 824 through layer 906 to a second fluid discharge destination 918. Fluid ejection orifices 830 extend from channel 824 in different directions. In the example illustrated, fluid ejection orifices 830 extend from channel 830 in opposite directions, perpendicular to channel 824 and parallel to one another.

Fluid actuators 832 selectively and controllably eject fluid within channel 824 through their respective fluid ejection orifices 830-1, 830-2. Fluid actuator 832-1 and fluid actuator 832-2 are both located on one same side of channel 524. In one implementation, fluid actuators 532 are both located on or supported by die 903. In such an implementation, fluid actuator 832-1 comprises an inverted fluid actuator. Fluid ejection orifice 830-1 is located opposite to fluid ejection orifice 830-2.

In one implementation, both of such fluid actuators 832 may comprise similar types of fluid actuators. In other implementations, fluid actuators 832 may comprise different types of fluid actuators. Examples various types of fluid actuators include, but are not limited to, a thermal resistive fluid actuator, a piezo-membrane based actuator, an electrostatic membrane actuator, a mechanical/impact driven membrane actuator, a magnetostrictive drive actuator, an electrochemical actuator, an external laser actuator (that forms a bubble through boiling with a laser beam), other such microdevices, or any combination thereof. In one implementation, each of fluid actuators 832 comprises a thermal resistive fluid actuator wherein electrical current is supplied to a thermal resistor so as to generate heat sufficient to vaporize adjacent fluid to create a drive bubble that pushes our expels non-vaporized fluid through the associated fluid ejection orifice 830-1, 830-2.

Body 900 defines a first portion 920 of fluid input 914. In one implementation, body 900 may be formed from silicon. In other implementations, body 900 may be formed from other materials such as glass, gallium arsenide, quartz, sapphire, metal, plastics, etc. in one implementation, body 900 is bonded or fixed to the remaining layers by an epoxy adhesive layer.

Inlet-outlet layer 902 comprises a layer of material between body 900 and orifice layer 904. Layer 902 forms a second portion 924 of fluid inlet 914 and a second portion of the fluid discharge destination 916. In the example illustrated, layer 902 is over molded about or at least partially encapsulates die 903. In one such implementation, layer 902 may be formed from an epoxy mold compound.

Die 903 comprises a platform upon which electronic circuitry of dispenser 820 is supported. In one implementation, die 903 may comprise a silicon or silicon-based substrates. Die 903 supports the electronic circuitry forming fluid actuators 832. In the example illustrated, die 903 further supports the electronic circuitry associated with fluid analyzer 911. In one implementation, die 903 may comprise what is referred to as a “sliver”. A die “sliver” means a circuit die with a ratio of length to width greater than 50. In some implementations, a die “sliver” means a circuit die with a ratio of length to width of 75 or more. In some implementations, the individual circuit dies may have a ratio of length to width of 50 or less.

Orifice layer 904 comprises a layer of material forming and defining fluid channel 824 as well as filter 910. Orifice layer 904 is formed upon layer 902. In one implementation, orifice layer 904 is formed from a photoresist, such as a photoresist epoxy. In one implementation, orifice layer 904 comprises a patterned layer of SU8.

Orifice layer 906 comprises at least one layer of material joined to layer 904. Layer 906 forms a floor of fluid channel 824. Layer 806 further defines fluid ejection orifice 830-2 which extends through portions of layer 906. Because both of fluid actuators 832 are supported by layer 904, along with their associated electronic circuitry, layer 906 may be simplified, omitting electrically conductive traces, circuitry or the like. As a result, layer 906 may be formed from epoxies such as SU8. In some implementations, layer 906 may be provided as a gasket joined to layer 604.

Diaper 908 comprises a gas permeable layer that retains fluid, in the form of a liquid, within the reservoir formed by discharge destination 916 while venting the reservoir formed by discharge destination 916 to atmosphere. In one implementation, diaper 908 may be formed from cellulose fibers. In another implementation, diaper 608 may be formed from superabsorbent polymers or hydrogels. In yet other implementations, diaper 608 may be formed from a polymer, cotton, microfiber, plastic fiber, and the like.

Filter 910 comprise a constriction or other grid-like material within channel 824 and positioned between ejection orifice 830-1 and fluid ejection orifice 830-2. Filter 910 blocks particles greater than a predetermined size such that particles greater than the predetermined size may not pass to the region of channel 824 adjacent to fluid ejection orifice 830-2. For example, in some implementations where a sample contains proteins and a contaminant/analyte to be detected or identified, the proteins may be concentrated to sizes sufficiently large so as to not be passable through or across filter 910, wherein the larger sized proteins may be discharged through fluid ejection orifice 830-1 while the remaining fluid containing the contaminants or other analytes to be identified and analyzed may pass across filter 910 ejection through fluid ejection orifice 830-2. In other implementations, the sample can include beads that carry an analyte of interest on their surfaces. In this example, the beads will be trapped by filter 910 are prevented from being ejected by actuator 832-2 through ejection orifice 830-2.

In the example illustrated, filter 910 comprise a constriction in channel 824 formed by the protruding portion of layer 904. In other implementations, filter 910 may comprise a constriction formed by a protruding portion of die 903 and/or layer 904. In yet other implementations, filter 910 may be bonded or otherwise joined to layer 904, die 903 and/or layer 906 between orifices 830.

Fluid analyzer 911 comprises electronic circuitry that facilitates the identification or other analysis of fluid that has passed filter 910. In one implementation, fluid analyzer 911 comprises at least one plasmonically active surface that facilitates surface enhanced Raman spectroscopy. In other implementations, fluid analyzer 911 may comprise other structures or surfaces to facilitate other fluid analysis techniques and protocols with respect to the fluid within channel 824. In some implementations, fluid analyzer 911 may be omitted or provided elsewhere.

Controller 612 is described above. Controller 612 controls the selective ejection of fluid through orifices 830. In one implementation, controller 612 may further control fluid analyzer 911. In one implementation, controller 612 (schematically shown) may be formed on or in die 903. In other implementations, controller 62 may be formed elsewhere on dispenser 820. In yet other implementations, controller 612 may be provided remote from body 522, wherein the controller communicates through a wired or wireless connection with fluid actuators 832 on the body of dual direction dispenser 820.

In one implementation, dual direction dispenser 520 further comprises at least one sensor 934 that senses the presence and/or flow of fluid. In such an implementation, processor 632, following instructions contained in media 630 may actuate fluid actuators 832 of fluid ejectors 828 based upon signals from the at least one sensor 934. Although sensor 934 is illustrated as being located proximate to fluid ejection orifice 830-2 and fluid actuator 832-2, in other implementations, sensor 934 may alternatively or additionally be provided at other locations such as proximate to fluid ejection orifice 830-1, within a fluid discharge destination 916 or within fluid discharge destination 918. In one implementation, sensor 934 may comprise an impedance sensor.

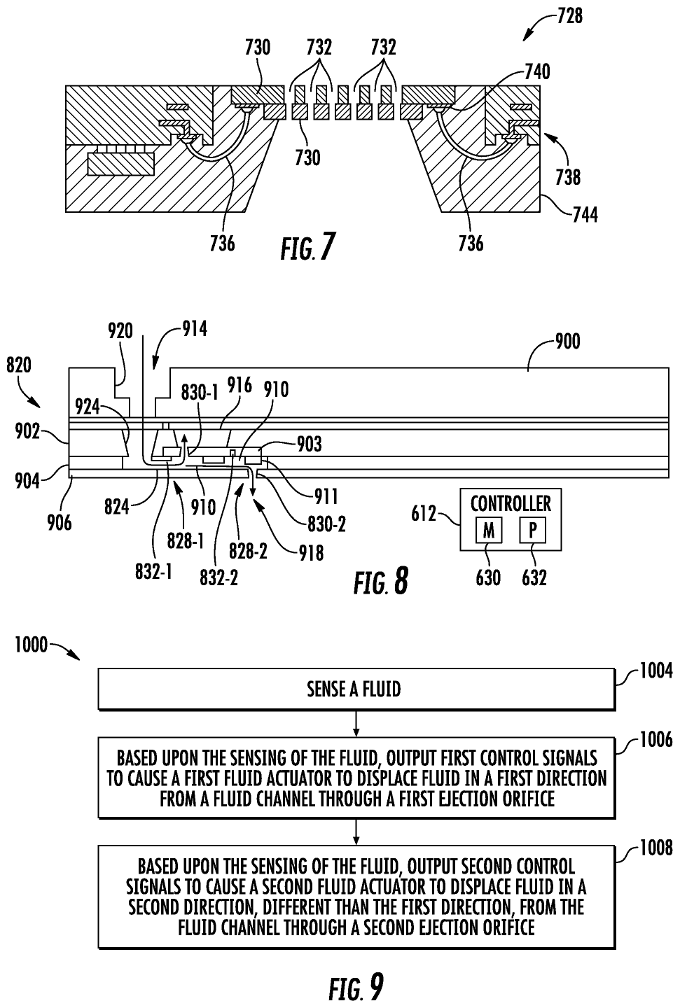

FIG. 9 is a flow diagram of an example dual direction fluid dispensing method 1000. Method 1000 facilitates controlled and selective dispensing of fluid in different directions from a fluid passage. In the example illustrated, medium 630 of controller 612 contains instructions for causing processor 632 to carry out method 1000. Although method 1000 is described in the context of being carried out with dual direction dispenser 820, method 1000 may be utilized with any of the dual direction dispensers described herein or with other similar will direction dispensers.

As indicated by block 1004, processor 632 senses the fluid by receiving signals from sensor 934 indicating a characteristic of the fluid. As noted above, the sensing of the fluid may take place at a variety of different locations. As indicated by block 1006, based upon the sensing of the fluid, processor 632 of controller 612 outputs first control signals to cause the first fluid actuator, such as fluid actuator 832-1, to displace fluid in a first direction from a fluid channel, such as fluid channel 824, through a first ejection orifice, such as fluid ejection orifice 830-1. As indicated by block 1008, processor 632 of controller 612 outputs second control signals, based upon the sensing of the fluid, that cause a second fluid actuator, such as fluid actuator 832-2, to displace fluid in a second direction, different than the first direction, from the fluid channel 824 through a second fluid ejection orifice, such as fluid ejection orifice 830-2.

FIG. 10 is a sectional view illustrating portions of an example dual direction dispenser 1020. Dual direction dispenser 1020 is similar to dual direction dispenser 520 described above except that dual direction dispenser 1020 comprises fluid discharge destinations 1116 and 1118 in place of destinations 616 and 618, respectively. Dual direction sensor 1020 further comprises multiple fluid sensors 1134-1, 1134-2, 1134-3 and 1134-4 (collectively referred to as sensors 1134). Those remaining components of dual direction dispenser 1020 which correspond to components of dual direction dispenser 520 are numbered similarly.

Fluid discharge destination 1116 comprises a receiving reservoir 1121 which is vented to atmosphere by vent 1123 and a fluid processing channel 1125 that directs fluid ejected through fluid ejection orifice 530-1 to further downstream processing stations on the package including dispenser 1020.

Fluid discharge destination 1118 stores waste portions of the fluid, fluid that has been ejected through fluid ejection orifice 530-2. Fluid discharge destination 1118 comprises a secondary body 1130 that forms a reservoir 1132 for containing the waste discharged fluid. In the example illustrated, destination 1118 further comprises diaper 608 which retains liquid within reservoir 1132 while venting gas within reservoir 1132 to atmosphere. In other implementations, diaper 608 may be omitted.

Sensors 1134 sense the presence or flow characteristics of fluid. Sensors 1134 may sense the size of particles in the fluid, the number of particles in the fluid and/or the rate of flow of such particles or fluid. Sensors 1134 may be a set of homogenous sensors or may be heterogeneous. Examples of sensors 1134 include, but are not limited to, optical sensors and impedance sensors. Sensors 1134 output signals which are communicated to controller 612, wherein controller 612 may use such signals carry out method 1000 described above.

In the example illustrated, sensor 1134-1 senses fluid within channel 524 prior to the fluid reaching or passing filter 610. Sensor 1134-2 senses fluid that is been ejected through fluid ejection orifice 530-1. Sensor 1134-3 senses fluid that has passed filter 610, but has not yet been ejected through fluid ejection orifice 530-2. Sensor 1134-4 senses fluid that has been ejected through fluid ejection orifice 530-2. In other implementations, additional sensors may be provided at other locations. In some implementations, at least some of sensors 1134 may be omitted.

The broken lines in FIG. 10 illustrate one example application of dual direction dispenser 1020. It should be appreciated dual direction dispenser 1020 may be used with other methods or applications as well. In the example illustrated, dual direction dispenser 1020 may be utilized to carry out nucleic acid testing. In such an application, dual direction dispenser 1020 facilitates the isolation of DNA or RNA in a sample for amplification and detection.

According to one example method, beads 1200 having functionalized surfaces may be located within channel 524. In one implementation, beads 1200 may be suspended in a fluid that is directed through channel 524, wherein the beads 1200 in the fluid become trapped in channel 524 by retainer filter 1202. Thereafter, a sample containing an analyte (DNA or RNA in one implementation) is directed through channel 524, wherein the analyte binds to the functionalized surfaces of the beads while the remaining portions of the sample are ejected by fluid ejector 528-2 to reservoir 1132 of fluid discharge destination 1118.

In an alternative implementation, the beads are mixed with a sample upstream where the analyte binds to the surface of the beads. Sample beads with the bound analyte are passed through channel 524 and retained by filter 1202. In either implementation, during a subsequent elution step, the analyte is removed from the beads 1200 with an elution solution. The elution solution is ejected by fluid ejector 528-1 to fluid discharge destination 1116 where the analyte is further directed through channel 1125 downstream to an amplification and detection station 1210. At station 1210, the analyte undergoes amplification and detection. In one implementation, the amplification and detection station 1210 carries out a polymerase chain reaction (PCR) process.

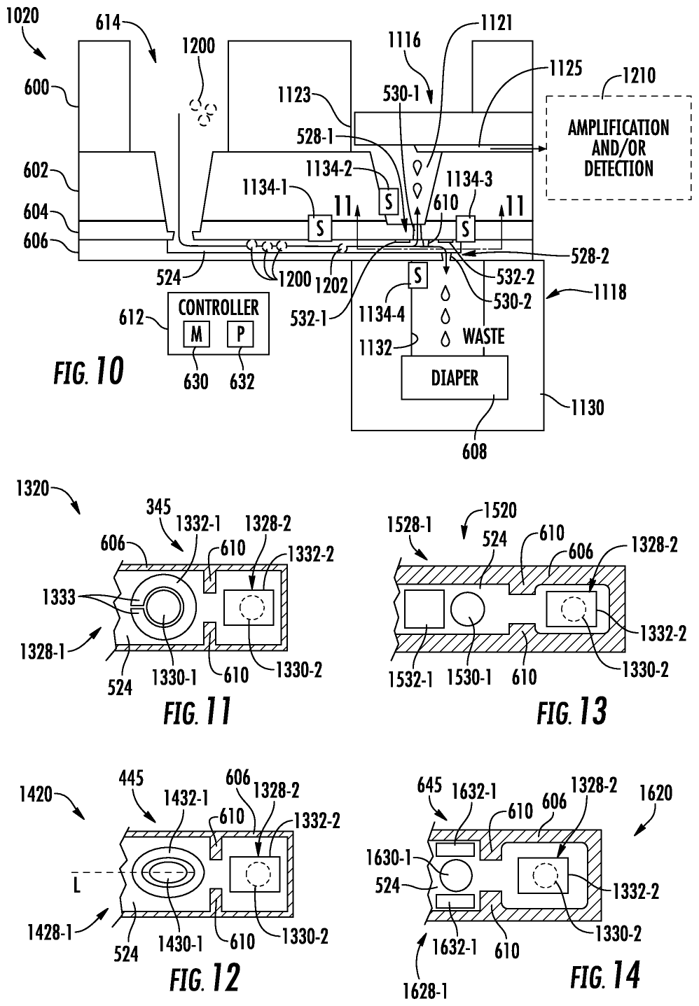

FIGS. 11-14 illustrate portions of different dual direction dispensers 1320, 1420, 1520 and 1620, respectively. Each of dual direction dispensers 1320, 1420, 1520 and 1620 is similar to dual direction dispenser 1020 described above except that each of dispensers 1320, 1420, 1520 and 1620 comprises a different fluid ejector in place of fluid ejector 528-1. In the example illustrated, each of dispensers 1320, 1420, 1520 and 1620 comprises a fluid ejector 1328-2 in place of fluid ejector 528-2. All other components of dispensers 1320, 1420, 1520 and 1620 correspond to portions of dispenser 1020 and are either numbered similarly or are shown and described with respect to FIG. 10. FIGS. 11-14 are each taken along line 11-11 of FIG. 10.

Fluid ejector 1328-2 comprises fluid ejection orifice 1330-2 through which fluid is ejected by actuation of a corresponding or associated fluid actuator 1332-2. In the example illustrated, fluid actuator 1332-2 comprise a thermal resistive fluid actuator. In other implementations, fluid actuator 1332-2 may comprise other forms of fluid actuators.

Dual direction dispensers 1320, 1420, 1520 and 1620 comprise fluid ejectors 1328-1, 1428-1, 1528-1 and 1628-1, respectively. Each of fluid ejectors 1328-1, 1428-1, 1528-1 and 1628-1 include a different inverted fluid actuator to controllably and selectively displace fluid through an associated fluid ejection orifice. FIG. 11 illustrates fluid ejector 1328-1 that comprises an actuator 1332-1 disposed around the fluid ejection orifice 1330-1. As shown by FIG. 11, actuator 1332-1 is substantially donut-shaped, covering almost a full circle wherein opposite ends 1333 are disconnected. These ends 1333 may extend close to each other. Electrodes may contact each end of the actuator 1332-1 for actuation. In different examples the actuator 1332-1 may cover at least 270 degrees around the nozzle or fluid ejection orifice 1330-1, or at least 345 degrees, and less than approximately 358 degrees, or less than approximately 350 degrees. In another example the actuator 1332-1 could be circular shaped and cover a full circle whereby opposite electrodes may contact the inner and outer edges of the actuator 1332-1, or opposite outer edges of the actuator 1332-1 on opposite sides of the fluid ejection orifice 1330-1.

FIG. 12 illustrates fluid ejector 1428-1 wherein the fluid ejection orifice 1430-1 is non-circular shaped. In the example illustrated, the fluid ejection orifice 1430-1 is symmetrical along a longitudinal axis L. The fluid ejection orifice 1430-1 may have a substantially longitudinal shape along said axis L, and/or an elliptical shape whereby a length direction of the ellipse extends along the longitudinal axis L. The actuator 1432-1 may extend around the nozzle 407 wherein the inner and outer edge of the actuator 1432-1 may be offset from the circumference of the inlet of the fluid ejection orifice 1430-1. In different examples the actuator 1432-1 may extend fully or partially around the 1430-1. For example, the actuator 1432-1 may be interrupted so as to be defined by four separate actuators 1432-1.

FIG. 13 illustrates fluid ejector 1528-1 wherein a fluid actuator 1532-1 extends next to the fluid ejection orifice 1530-1 on an opposite side of the fluid ejection orifice 1530-1 with respect to filter 610. In another example, two resistors could be disposed along opposite sides of the fluid ejection orifice 1530-1, for example one resistor as shown in FIG. 13 and another resistor between the fluid ejection orifice 1530-1 and the filter 610. In yet another example, a single resistor may extend along one side of the fluid ejection orifice 1530-1, between the fluid ejection orifice 1530-1 and the filter 610.

FIG. 14 illustrates fluid ejector 1628-1 wherein fluid actuator 1632-1 extends on opposite sides of the fluid ejection orifice 1630-1. The actuators 611 may extend laterally to the fluid ejection orifice 1630-1 with respect to channel 524. In other examples more than two separate actuators may extend around the fluid ejection orifice 1630-1, at different sides of the nozzle. In again other examples, different shapes, numbers and locations of actuators can be chosen to extend next to, and/or at least partially around, a single nozzle, and on the same wall as the nozzle inlet.

Although each of the above described dual direction dispensers illustrates two fluid ejection orifices extending at different directions from a single channel, in other implementations, each of such dual direction dispensers may comprise additional fluid ejection orifices and associated additional fluid actuators. For example, in other implementations, dual direction dispenser 1020 may comprise an additional fluid ejection orifice extending through layer 604 from channel 524 to yet a third discharge destination. In such an implementation, the additional fluid ejection orifices may be associated with an inverted fluid actuator, similar to fluid actuator 532-1 supported by layer 604. In other implementations, dual direction dispenser 1020 may comprise an additional fluid ejection orifice extending through layer 606 to yet a third discharge destination. In such an implementation, the addition of fluid ejection orifice may be associated with a fluid actuator, similar to fluid actuator 532-2 supported by layer 604. In another implementation, dual direction dispenser 1020 may comprise an additional fluid ejector similar to fluid ejector 528-1 and an additional fluid ejector similar to fluid ejector 528-2.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A dual direction dispenser comprising:
a fluid channel;
a first ejection orifice extending in a first direction from the fluid channel;
a first fluid actuator to displace fluid through the first ejection orifice;
a second ejection orifice extending in a second direction, different than the first direction, from the fluid channel; and
a second fluid actuator to displace fluid through the second ejection orifice.

2. The dual direction dispenser of claim 1 further comprising a filter across the fluid channel between the first ejection orifice and the second ejection orifice.

3. The dual direction dispenser of claim 1, wherein the second direction and the first direction are opposite parallel directions.

4. The dual direction dispenser of claim 1 further comprising a waste storage chamber connected to an output of the first ejection orifice, the way storage chamber being vented to atmosphere.

5. The dual direction dispenser of claim 1 further comprising:
a fluid inlet connected to the fluid channel;
a way storage chamber connected to one of the first ejection orifice and the second ejection orifice; and
a second channel, at least a portion of which extends parallel to the first channel, connected to the other of the first ejection orifice and the second ejection orifice.

6. The dual direction dispenser of claim 1 further comprising:
a first layer; and
a second layer on a first side of the first layer,
wherein at least a portion of the channel is sandwiched between the first layer and the second layer,
wherein the first ejection orifice extends through the first layer,
wherein the first fluid actuator is supported by the first layer,
wherein the second ejection orifice extends through the second layer, and
wherein the second fluid actuator is supported by the first layer.

7. The dual direction dispenser of claim 6 further comprising a filter across the fluid channel between the first ejection orifice and the second ejection orifice.

8. The dual direction dispenser of claim 6 further comprising:
a fluid inlet connected to the fluid passage;
a waste storage chamber connected to one of the first ejection orifice and the second ejection orifice; and
a second channel, at least a portion of which extends parallel to the first channel, connected to the other of the first ejection orifice and the second ejection orifice.

9. The dual direction dispenser of claim 6 further comprising:
a third ejection orifice extending from the fluid channel; and
a third fluid actuator to displace fluid through the third ejection orifice.

10. The dual direction dispenser of claim 6, wherein the first layer comprises silicon and wherein the second layer comprises at least one material selected from a group of materials consisting of: an epoxy resin, dielectric, polyamide, metal and other polymer materials.

11. The dual direction dispenser of claim 6, wherein the first layer and the second layer part of a package that comprises an analyte analysis station connected to an outlet of the first ejection orifice.

12. The dual direction dispenser of claim 1, wherein the first ejection orifice has a mouth extending on a surface and wherein the first fluid actuator extends adjacent the mouth on the surface.

13. A dual direction dispenser fluid dispensing method comprising:
directing a fluid along a fluid channel;
ejecting a first portion of the fluid from the fluid channel in a first direction; and
ejecting a second portion of the fluid from the fluid channel in a second direction different than the first direction.

14. The dual direction dispenser fluid dispensing method of claim 13, wherein the fluid channel extends within a package, the method further comprising receiving and storing the second portion of the fluid within a storage chamber of the package that is vented to atmosphere.

15. A non-transitory computer-readable medium containing dual direction dispenser instructions to direct a processing unit to:
sense a fluid;
based upon the sensing of the fluid, output first control signals to cause a first fluid actuator to displace fluid in a first direction from a fluid channel through a first ejection orifice; and
based upon the sensing of the fluid, output second control signals to cause a second fluid actuator to displace fluid in a second direction, different than the first direction, from the fluid channel through a second ejection orifice.
